(19) United States
(12) Patent Application Publication
(10) Pub. No.: US 2026/0267591 A1
(43) Pub. Date: Sep. 10, 2026

(54) HOUSEHOLD APPLIANCE AUDIO OUTPUT OPTIMIZATION

(71) Applicant: Haier US Appliance Solutions, Inc., Wilmington, DE (US)

(72) Inventor: Christopher Hayward Osborne, Louisville, KY (US)

(21) Appl. No.: 19/070,606

(22) Filed: Mar. 5, 2025

(51) Int. Cl. G06F 3/16; F25D 29/00; H04R 1/02; H04R 3/04

(52) U.S. Cl. CPC G06F 3/165; F25D 29/00; H04R 1/028; H04R 3/04; H04R 2430/01

(57) ABSTRACT

A household appliance includes a cabinet defining an internal volume for receiving one or more items and treating the one or more items within the internal volume. The household appliance also includes a user interface positioned at an external surface of the household appliance. The user interface includes a speaker. The household appliance may further include a controller configured for, and/or a method of operating the household appliance may include, receiving a user selection including an audio profile. An audio output for the speaker may be processed according to a main system equalizer and according to the user-selected audio profile. The speaker may be operated to generate the processed audio output.

### FIELD

The present subject matter relates generally to household appliances, and more particularly to features for optimizing audio output of the household appliances.

### BACKGROUND

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

The user interaction with such household appliances may be enhanced by audio feedback and/or audio playback (such as audio-only playback, e.g., music streaming or multimedia playback including visual and audio output from the appliance) provided from the household appliance. Where such appliances are used for a variety of tasks and in a variety of settings, and in particular where the setting may vary from one installation to another, the acoustic environment of a particular household appliance unit may be unique to that unit and may thusly create inconsistencies in the level of performance and quality provided in the audio output (e.g., feedback and/or playback, as mentioned) from one unit to another.

Accordingly, systems and methods for customizing the audio output from a household appliance are desired in the art.

### BRIEF DESCRIPTION

Aspects and advantages of the invention will be set forth in part in the following description, or may be apparent from the description, or may be learned through practice of the invention.

In one exemplary embodiment, a household appliance is provided. The household appliance includes a cabinet defining an internal volume for receiving one or more items and treating the one or more items within the internal volume. A user interface is positioned at an external surface of the cabinet. The user interface includes a speaker. The household appliance also includes a controller. The controller is in operative communication with the user interface. The controller is configured for receiving a user selection. The user selection includes an audio profile. The controller is also configured for processing an audio output for the speaker. Processing the audio output includes equalizing the audio output according to a main system equalizer stored in a memory of the controller and equalizing the audio output according to the audio profile. The controller is further configured for operating the speaker to generate the processed audio output.

In another exemplary embodiment, a method of operating a household appliance is provided. The household appliance includes a cabinet defining an internal volume for receiving one or more items and treating the one or more items within the internal volume and a user interface positioned at an external surface of the cabinet. The user interface includes a speaker. The method includes receiving a user selection. The user selection includes an audio profile. The method also includes processing an audio output for the speaker. Processing the audio output includes equalizing the audio output according to a main system equalizer stored in a memory of the controller and equalizing the audio output according to the audio profile. The method further includes operating the speaker to generate the processed audio output.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a household appliance, e.g., a refrigerator appliance, according to one or more exemplary embodiments of the present subject matter.

FIG. 2 provides an additional perspective view of the exemplary refrigerator appliance of FIG. 1 with doors of the refrigerator appliance in an open position.

FIG. 3 provides an enlarged view of a portion of a user interface of a household appliance according to one or more exemplary embodiments of the present disclosure.

FIG. 4 provides a flow diagram of an audio processing logic for audio output of a household appliance according to one or more exemplary embodiments of the present disclosure.

FIG. 5 provides a flowchart illustrating an exemplary method of operating a household appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

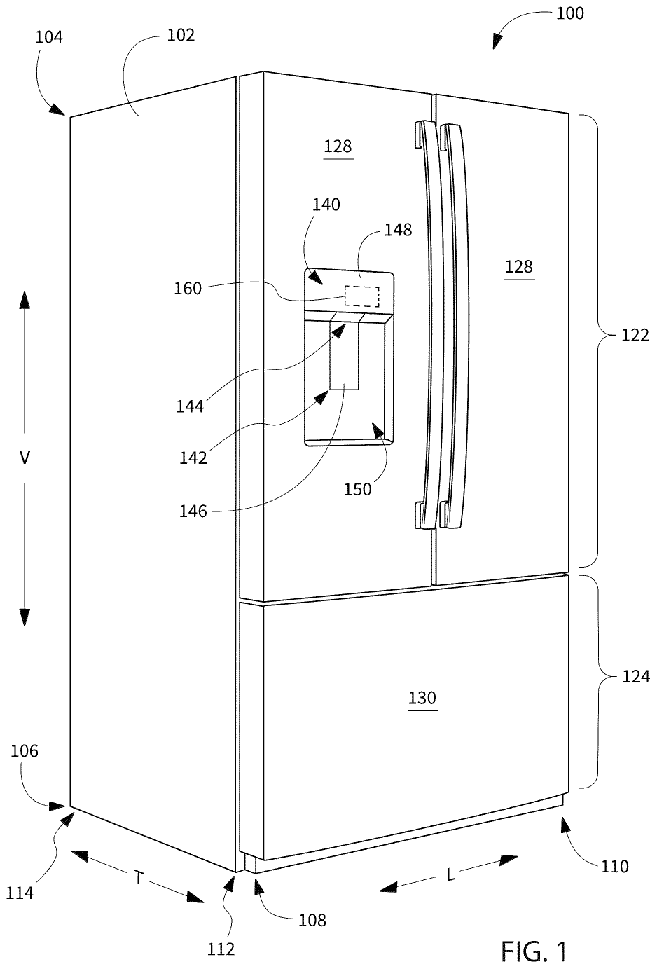

It should be understood that “household appliance” and/or “appliance” are used herein to describe appliances typically used or intended for common domestic tasks, such as a refrigerator appliance, e.g., as illustrated in FIGS. 1 through 3, or an air conditioner appliance, a dishwashing appliance, a laundry appliance (e.g., washing machine and/or dryer appliance), a water heater, etc., and any other household appliance which performs similar functions in addition to network communication and data processing. Accordingly, it will be recognized that the domestic task(s) which the appliance is configured to perform include operating on tangible matter (e.g., water, air, food items, laundry articles, and/or other such matter) to change a physical attribute (e.g., temperature, pressure, position, velocity, etc.) of the tangible matter using a mechanical component of the appliance. Thus, devices such as a personal computer, router, and other similar devices whose primary functions are network communication and/or data processing are not considered household appliances as used herein. Additionally, the “household” appliances are not limited to only residential settings, such appliances may also be used, e.g., in a hotel or office building, to perform the aforementioned domestic tasks.

The present disclosure generally pertains to household appliances and methods of operating the same. For example, the household appliance may include a cabinet defining an internal volume for receiving one or more items and treating the one or more items within the internal volume. In the illustrated exemplary embodiment which will be described further below, the household appliance may be a refrigerator appliance and the internal volume may include one or more food storage chambers (e.g., fresh food and/or freezer chambers) for receiving items such as food and beverage items and for treating said items, e.g., cooling the items to prolong a usable life thereof. In an additional exemplary embodiment, the household appliance may be a cooking appliance and the internal volume may include one or more cooking chambers for providing thermal energy to (i.e., heating) food items therein, such as providing microwave energy, radiant heating, and/or other suitable heating elements for cooking. In additional exemplary embodiments, the household appliance may be a laundry appliance and the internal volume may be a wash chamber of a tub in a washing machine appliance or a chamber within a drum of a dryer appliance, for receiving and treating (e.g., washing, rinsing, drying, etc.) laundry items therein.

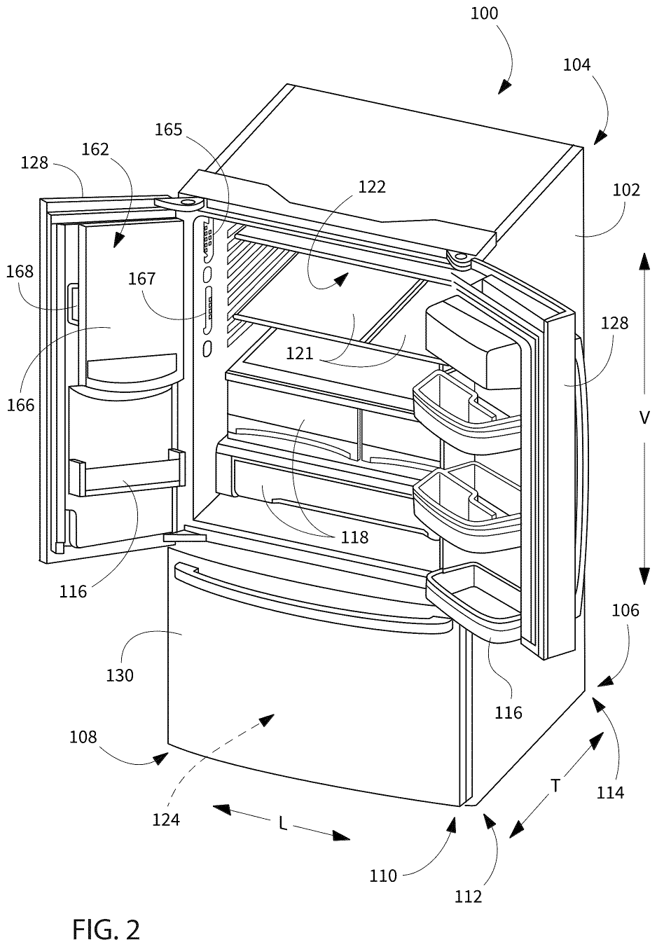

Referring now to the figures, FIGS. 1 and 2 provide perspective views of an exemplary household appliance, e.g., refrigerator appliance 100, according to one or more exemplary embodiments of the present subject matter. The refrigerator appliance may define a vertical direction V, a lateral direction L, and a transverse direction T. The vertical direction V, the lateral direction L, and the transverse direction T may each be mutually perpendicular to one another to generally form an orthogonal coordinate system.

As illustrated in FIGS. 1 and 2, the refrigerator appliance 100 may include a housing or a cabinet 102 that may extend between a top 104 and a bottom 106 approximately along a vertical direction V, between a first side (left side) 108 and a second side (right side) 110 approximately along a lateral direction L, and between a front 112 and a back 114 approximately along a transverse direction T. The cabinet 102 may define one or more chilled chambers for receipt of food items for storage. In some embodiments, the cabinet 102 may define a fresh food chamber 122 positioned at or adjacent the top 104 of the cabinet 102 and a freezer chamber 124 arranged at or adjacent the bottom 106 of the cabinet 102. As such, the refrigerator appliance 100 may generally be referred to as a bottom mount refrigerator.

It is recognized, however, that the benefits of the present disclosure apply to other types and styles of refrigerator appliances such as, for example, a top mount refrigerator appliance, a quad door refrigerator appliance, a side-by-side refrigerator, or other similar refrigerator appliances. Consequently, the description set forth herein is for illustrative purposes only and is not intended to be limiting in any aspect to any particular household appliance, such as the present subject matter is not limited to any particular refrigerator chamber configuration. Accordingly, it should be recognized that aspects of the present disclosure may be used with a variety of refrigerator appliances and/or other household appliances as mentioned above.

The refrigerator doors 128 may be rotatably hinged to an edge of the cabinet 102 for selectively accessing the fresh food chamber 122. In addition, a freezer door 130 may be arranged below the refrigerator doors 128 for selectively accessing the freezer chamber 124. The freezer door 130 may be coupled to a freezer drawer (not shown) slidably mounted within the freezer chamber 124. The refrigerator doors 128 and the freezer door 130 are shown in the closed configuration in FIG. 1.

In some embodiments, various storage components may be mounted within the fresh food chamber 122 to facilitate storage of food items therein. In particular, the storage components may include storage bins 116, drawers 118, and shelves 121 that may be mounted within the fresh food chamber 122. As such, the storage bins 116, drawers 118, and shelves 121 are configured for receipt of food items, for example, beverages or solid food items, and may assist with organizing such food items. As an example, the drawers 118 can receive fresh food items, for example, vegetables, fruits, or cheeses, and increase the useful life of such fresh food items.

In some embodiments, the refrigerator appliance 100 may also include a dispensing assembly 140 for dispensing liquid water or ice. The dispensing assembly 140 may include a dispenser 142, for example, positioned on or mounted to an exterior portion of the refrigerator appliance 100, such as on one of the refrigerator doors 128. Moreover, as shown in FIG. 1, the dispenser 142 may include a discharging outlet 144 for accessing ice and liquid water. Further, an actuating mechanism 146, shown as a paddle, may be mounted below the discharging outlet 144 for operating the dispenser 142. In alternative embodiments, any suitable actuating mechanism may be used to operate the dispenser 142. A user interface panel 148 may also be provided for controlling the mode of operation. For example, the user interface panel 148 may include a plurality of user inputs (not labeled), such as a water dispensing button and an ice-dispensing button, for selecting a desired mode of operation such as crushed or non-crushed ice.

Still referring to FIG. 1, the discharging outlet 144 and actuating mechanism 146 may be an external part of the dispenser 142 and may be mounted in a dispenser recess 150. The dispenser recess 150 may be positioned at a predetermined elevation convenient for a user to access ice or water and enabling the user to access ice without the need to bend over and without the need to open the refrigerator doors 128. In additional embodiments, the dispenser recess 150 may be positioned at a level that approximates the chest level of a user.

In further embodiments, for example, as shown in FIG. 2, the refrigerator appliance 100 may include a sub-compartment 162 defined on the refrigerator door 128. The sub-compartment 162 is often referred to as an “icebox.” Further, the sub-compartment 162 may extend into fresh food chamber 122 when the refrigerator door 128 is in the closed position. Although the sub-compartment 162 is shown in the refrigerator door 128, additional or alternative embodiments may include the sub-compartment 162 fixed within fresh food chamber 122. In an embodiment, an ice maker and/or an ice storage bin (not shown) may be positioned or disposed within the sub-compartment 162. Accordingly, during use, ice can be supplied to the dispenser recess 150, see, for example, FIG. 1, from the ice making assembly or ice storage bin in the sub-compartment 162 on a back side of refrigerator door 128.

In additional or alternative embodiments, chilled air from a sealed system of the refrigerator appliance 100 may be directed into components within the sub-compartment 162. For instance, the sub-compartment 162 may receive cooling air from a chilled air supply duct 165 and a chilled air return duct 167 (see, for example, FIG. 2), disposed on a side portion of cabinet 102 of the refrigerator appliance 100. In this manner, the chilled air supply duct 165 and the chilled air return duct 167 may recirculate chilled air from a suitable sealed cooling system through the sub-compartment 162.

In optional embodiments, for example, as illustrated in FIG. 2, an access door 166 may be hinged to the refrigerator door 128. Thus, the access door 166 may permit selective access to the sub-compartment 162. Any manner of suitable latch 168 may be configured with the sub-compartment 162 to maintain the access door 166 in a closed position. As an example, the latch 168 may be actuated by a user in order to open the access door 166 for providing access into the sub-compartment 162. The access door 166 can also assist with insulating the sub-compartment 162 (e.g., by thermally isolating or insulating the sub-compartment 162 from the fresh food chamber 122). It is noted that although the access door 166 is illustrated in exemplary embodiments, alternative embodiments may be free of any separate access door.

Refrigerator appliance 100 further includes a controller 160. Operation of the refrigerator appliance 100 is regulated by controller 160 that is operatively coupled to user interface panel 148. In some exemplary embodiments, user interface panel 148 may represent a general purpose I/O (“GPIO”) device or functional block. In some exemplary embodiments, user interface panel 148 may include input components, such as one or more of a variety of electrical, mechanical or electro-mechanical input devices including rotary dials, push buttons, touch pads, and touch screens. User interface panel 148 can be communicatively coupled with controller 160 via one or more signal lines or shared communication busses. User interface panel 148 provides selections for user manipulation of the operation of refrigerator appliance 100, e.g., whereby a user may provide one or more set point temperatures for the various chilled chambers 122 and 124. In response to user manipulation of the user interface panel 148, controller 160 operates various components of refrigerator appliance 100. For example, controller 160 is operatively coupled or in communication with various airflow components, e.g., dampers and fans, as discussed below. Controller 160 may also be communicatively coupled with a variety of sensors, such as, for example, chamber temperature sensors or ambient temperature sensors. Such chamber temperature sensors and/or ambient temperature sensors may be or include thermistors, thermocouples, or any other suitable temperature sensor. Controller 160 may receive signals from these temperature sensors that correspond to the temperature of an atmosphere or air within their respective locations.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 160 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 160 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 160 may be operable to execute programming instructions or micro-control code associated with an operating cycle of refrigerator appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 160 as disclosed herein is capable of and may be operable to perform any methods, method steps, or portions of methods as disclosed herein. For example, in some embodiments, methods disclosed herein may be embodied in programming instructions stored in the memory and executed by controller 160.

The memory devices may also store data that can be retrieved, manipulated, created, or stored by the one or more processors or portions of controller 160. The data can include, for instance, data to facilitate performance of methods described herein. The data can be stored locally (e.g., on controller 160) in one or more databases and/or may be split up so that the data is stored in multiple locations. In addition, or alternatively, the one or more database(s) can be connected to controller 160 through any suitable network(s), such as through a high bandwidth local area network (LAN) or wide area network (WAN). In this regard, for example, controller 160 may further include a communication module or interface that may be used to communicate with one or more other component(s) of refrigerator appliance 100, controller 160, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

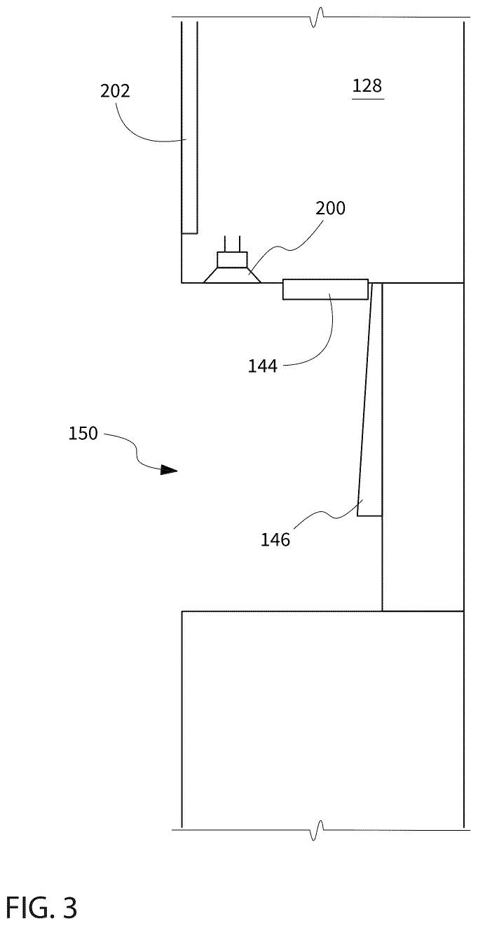

Referring now to FIG. 3, portions of an exemplary user interface for a household appliance are illustrated in the particular context of an example embodiment where the household appliance is a refrigerator appliance, such as refrigerator appliance 100. In various embodiments, the household appliance, e.g., refrigerator appliance 100, may include a user interface positioned at an external surface of the appliance, e.g., on the cabinet or door, and the user interface may include a speaker. In at least some embodiments, the user interface may also include a screen for presenting visual information, e.g., to a user, such as a touchscreen, and which may be, for example, a liquid crystal display (LCD) screen. For example, as illustrated in FIG. 3, the user interface may include a speaker 200 and a display (e.g., LCD screen) 202, each of which may be positioned at an external surface of the refrigerator appliance, where “external” in this context includes surfaces which are in contact with an ambient environment around (e.g., directly and immediately surrounding) the appliance. In some embodiments, e.g., as illustrated in FIG. 3, the speaker 200 may be positioned adjacent the dispenser recess 150. In such embodiments, the speaker 200 may be oriented into the dispenser recess 150, such that when the speaker 200 is operated the speaker 200 provides audio output into the dispenser recess 150, e.g., in such embodiments the audio waves and frequency ranges thereof as perceived by users of the refrigerator appliance may be altered by the dispenser recess 150 providing a resonance chamber.

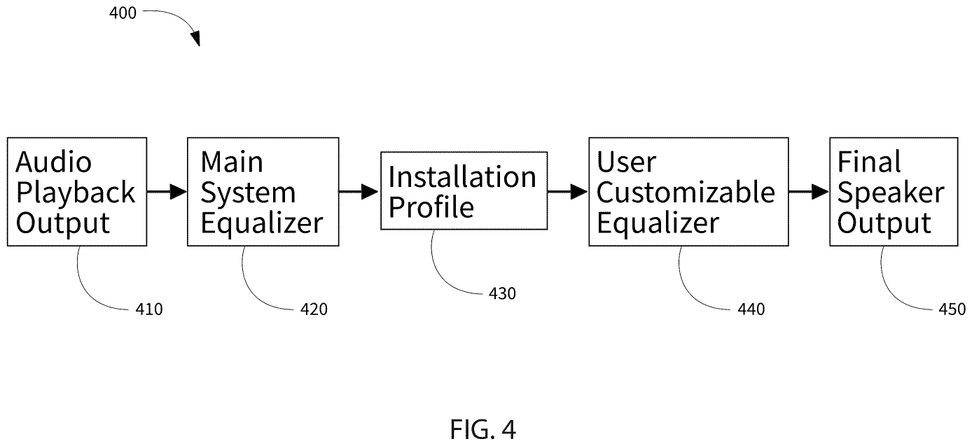

A logic flow diagram of an exemplary audio processing algorithm 400 for audio output to be produced by one or more speakers of a user interface of a household appliance is illustrated in FIG. 4. As illustrated in FIG. 4, the algorithm 400 may begin with a raw audio output 410, e.g., from a playback source such as an audio recording or stream, and which may be received from a controller, e.g., controller 160, of the household appliance. For example, an audio recording may be stored in a memory of the controller, an audio stream may be received by the controller from a remote device, such as over the internet or a short-range radio signal (e.g., BLUETOOTH® signal), and/or the raw audio output 410 may be provided from other similar sources via the controller.

The raw audio output 410 may be processed, e.g., equalized, according to various equalizer logics. That is, the levels of the audio output may be adjusted according to each equalizer logic, wherein the volume of different frequency bands within the audio signal from the raw audio output 410 is increased or decreased relative to each other and to the baseline levels in the raw audio output. Such adjustments to the levels of the audio output may be predefined to optimize the audio quality based on one or more parameters, such as inherent conditions in the system (e.g., the “system” in this context being the user interface of the household appliance), installation condition of the household appliance, and/or user preferences.

As illustrated in FIG. 4, the raw audio output 410 may be initially, and in at least some embodiments, primarily, adjusted according to a main system equalizer 420. For example, the equalization may be primarily according to the main system equalizer in that the magnitude of the adjustments to the levels of the audio signal in the total processing algorithm 400 may be predominantly those adjustments which occur according to the main system equalizer 420, such as about seventy-five percent (75%) or more, such as about eighty percent (80%) or more, such as about ninety percent (90%) or more, of the total magnitude of volume adjustments across the multiple equalizers in the algorithm 400 may be the adjustments according to the main system equalizer 420. The main system equalizer 420 may include a predefined set of adjustments to the audio signal which are designed to optimize the final output based on inherent conditions in the system, such as the size or type of speaker (or number of speakers, in embodiments where more than one speaker is provided), the location and orientation of the speaker(s) (such as when the speaker is oriented into a resonance chamber, such as the dispenser recess as described above in reference to the example illustrated in FIG. 3, or when the speaker is oriented upwards, downwards, or otherwise towards or away from the area in which a user is anticipated to be present (e.g., the area generally in front of the household appliance), and/or other similar conditions which do not vary significantly from one unit to another of the same model of household appliance.

As mentioned above, in various embodiments, installation conditions of the household appliance may influence the acoustics of the environment in which the household appliance is used, and therefore may impact the quality, e.g., fidelity and clarity, of audio output from the speaker of the user interface, including voice feedback or other voice outputs (as well as music and other audio outputs). For example, the installation conditions may be or may include the household appliance installed in a freestanding location, a corner installation, or a built-in installation. A freestanding installation may include installations with little to no other objects adjacent to the household appliance which may influence, e.g., muffle or otherwise distort, the audio output. A corner installation may include a wall of the structure, e.g., dwelling or household, in which the household appliance is installed within a certain distance of one lateral side (e.g., the left side or the right side) of the household appliance, where the certain distance may be about twelve inches (12″) or less, such as about eight inches (8″) or less, such as about six inches (6″) or less, such as about three inches (3″) or less. A built-in installation condition may include multiple walls within the certain distance of the household appliance on at least two sides, e.g., on at least two of top, left, and right sides of the household appliance, such as all three of the top, left, and right sides. The multiple walls in the built-in installation condition may be walls of the structure and/or furnishings (e.g., cabinetry) within the certain distance of the multiple sides of the household appliance.

Accordingly, an installation profile 430 may be provided in the algorithm 400, e.g., to optimize the audio signal for one of the above-mentioned example installation conditions, or other similar installation conditions, which may correspond to the acoustic environment in which the household appliance is used and the influence thereof on the audio output provided from the speaker(s) of the user interface of the household appliance. The installation profile 430 may be or may include a predefined equalizer logic and may be user-selected, such as the household appliance may be configured to provide a prompt on the user interface (e.g., on a display thereof) requesting an installation condition selection. The household appliance (e.g., the controller of the household appliance) may further be configured to receive a selection of one of the predefined installation conditions (e.g., freestanding, corner, built-in, etc.) and apply a corresponding predefined equalizer logic into the algorithm 400. As mentioned above, the adjustments to the raw audio output 410 may be made primarily according to the main system equalizer 420, and the magnitude of the adjustments (increases and/or decreases) to the various frequency bands within the audio signal made according to the installation profile 430 may be about ten to twenty percent of each respective volume level, e.g., the processing logic may proceed primarily according to the main system equalizer 420, and the installation profile 430 may provide optimization to the audio signal for the specific installation condition of the individual household appliance unit. In some embodiments, the magnitude of the adjustments to the various frequency bands within the audio signal made according to the installation profile 430 may be about thirty percent (30%) or less, such as about twenty percent (20%) or less, such as about ten percent (10%) or less, of each respective volume level (e.g., increasing or decreasing each volume level by no more than the stated exemplary percentage from the volume level provided after applying the main system equalizer 420).

In some embodiments, the algorithm 400 may also include an optional user-customizable equalizer 440. For example, the user-customizable equalizer 440 may permit a user, e.g., via interaction with one or more inputs of the user interface, such as on a touch-sensitive display of the user interface, to manually select adjustments to the volume levels of two or more predefined frequency bands (e.g., at least a bass adjustment and a treble adjustment). The user-customizable equalizer 440 may provide an optimization of the audio signal, e.g., may provide adjustments of the levels of the selected frequency range within a constrained range (e.g., percentage) in a similar manner as described above with respect to the installation profile.

After processing the raw audio output 410, e.g., after applying the main system equalizer 420, the installation profile 430, and/or the user-customizable equalizer 440, the algorithm 400 provides the final speaker output 450, e.g., the speaker(s) of the user interface may be driven to produce the final speaker output 450.

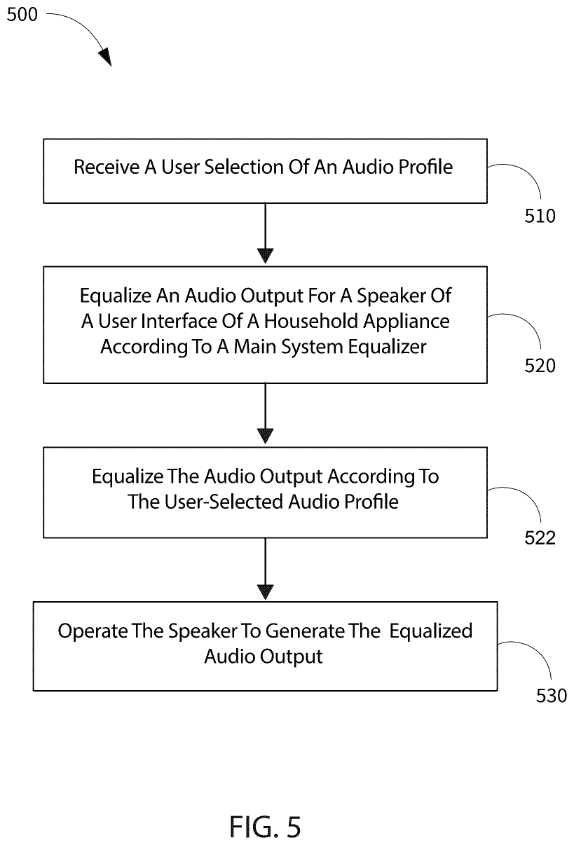

Turning now to FIG. 5, embodiments of the present disclosure may also include methods of operating a household appliance, e.g., refrigerator appliance 100 or other household appliances as described above, such as the exemplary method 500 illustrated in FIG. 5. It is noted that the order of steps within method 500 as depicted in FIG. 5 is for illustrative purposes. Except as otherwise indicated, one or more steps in the below method 500 may be changed, rearranged, performed in a different order, or otherwise modified without deviating from the scope of the present disclosure.

As illustrated in FIG. 5, method 500 may include (510) receiving a user selection of an audio profile. As mentioned, the method 500 may be used with any suitable household appliance, such as the refrigerator appliance 100 described above. More generally, the method 500 may be used with any suitable household appliance, such as a household appliance which includes a cabinet defining an internal volume for receiving one or more items and treating the one or more items within the internal volume (e.g., cooling food items in a refrigerator, heating food items in a cooking appliance such as an oven, washing and/or drying laundry items in a laundry appliance, etc.). Household appliances which may be used in the method 500 may also include a user interface positioned at an external surface of the household appliance, and the user interface may include a speaker. Thus, in some embodiments, the user input received at (510) may be received at the user interface of the household appliance. In additional embodiments, the user input received at (510) may be received remotely from an external device separate from the household appliance (e.g., from a remote user interface device such as a smartphone, personal computer, smart home system, or other similar remote user interface device) which communicates with the household appliance wirelessly (e.g., via BLUETOOTH®, or indirectly via a cloud system or other distributed computing environment that both the household appliance and the external device are connected to).

The audio profile may be one of a finite plurality of discrete selectable options, each having a predefined equalizer logic (e.g., a set of adjustments to the volume levels of predefined frequency bands in an audio signal to be provided from the user interface of the household appliance) corresponding thereto. The audio profile may, in some embodiments, be an installation profile. For example, a plurality of predefined equalizer logics may be provided (e.g., stored in a local memory of the controller of the household appliance), and a selected one of the predefined equalizer logics may be applied, where each predefined equalizer logic is attuned to a particular installation condition, such as freestanding, corner, built-in, etc., as described above.

As illustrated in FIG. 5, method 500 may also include processing an audio output for the speaker, e.g., as indicated at (520) and (522). Thus, processing the audio output may include (520) equalizing the audio output according to a main system equalizer and (522) equalizing the audio output according to the audio profile. The equalizers may be stored in a memory of the household appliance. After processing the audio output, the resultant audio signal, e.g., the processed audio output may then be provided, e.g., method 500 may further include (530) operating the speaker to generate the processed audio output.

As mentioned, the plurality of predefined audio profiles may be stored in a local memory of a controller of the household appliance. For example, the plurality of audio profiles may be developed in a laboratory setting (such as by a manufacturer of the household appliance using a prototype or other test unit of the same model of household appliance). The audio profiles may then be preprogrammed into the memory of the household appliance before the initial sale of the household appliance to a user. Additionally, audio profiles may be developed after the initial sale of the household appliance and may be provided to the household appliance via the internet, such as downloaded to the memory of the controller of the household appliance, such as from the cloud or other distributed computing environment. Thus, in some embodiments, methods according to the present disclosure, such as method 500, may include the plurality of predefined audio profiles stored in a memory of a remote computing device and downloading the audio profile from the remote computing device to a local memory of the controller of the household appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A household appliance comprising:
a cabinet defining an internal volume for receiving one or more items and treating the one or more items within the internal volume;
a user interface positioned at an external surface of the household appliance, the user interface comprising a speaker; and
a controller in operative communication with the user interface, wherein the controller is configured for:
receiving a user selection, the user selection comprising an audio profile;
processing an audio output for the speaker, wherein processing the audio output comprises equalizing the audio output according to a main system equalizer stored in a memory of the controller and equalizing the audio output according to the audio profile; and
operating the speaker to generate the processed audio output.

2. The household appliance of claim 1, wherein the audio profile is an installation profile.

3. The household appliance of claim 1, wherein the user selection comprises a selection of one of a plurality of predefined audio profiles.

4. The household appliance of claim 3, wherein the plurality of predefined audio profiles are stored in a local memory of the controller.

5. The household appliance of claim 3, wherein the plurality of predefined audio profiles are stored in a memory of a remote computing device, further comprising downloading the audio profile from the remote computing device to a local memory of the controller.

6. The household appliance of claim 1, wherein the household appliance is a refrigerator appliance, wherein the internal volume is a chilled chamber for receipt of food items and cooling of the food items therein.

7. The household appliance of claim 6, further comprising a dispenser recess, wherein the speaker is positioned adjacent the dispenser recess and oriented into the dispenser recess, wherein operating the speaker to provide the audio output after processing the audio output comprises emitting the audio output into the dispenser recess.

8. The household appliance of claim 1, wherein the audio output comprises voice feedback.

9. The household appliance of claim 1, wherein processing the audio output further comprises equalizing the audio output according to a user-customizable equalizer.

10. A method of operating a household appliance, the household appliance comprising a cabinet defining an internal volume for receiving one or more items and treating the one or more items within the internal volume and a user interface positioned at an external surface of the household appliance, the user interface comprising a speaker, the method comprising:
receiving a user selection, the user selection comprising an audio profile;
processing an audio output for the speaker, wherein processing the audio output comprises equalizing the audio output according to a main system equalizer stored in a memory of a controller of the household appliance and equalizing the audio output according to the audio profile; and
operating the speaker to generate the processed audio output.

11. The method of claim 10, wherein the audio profile is an installation profile.

12. The method of claim 10, wherein the user selection comprises a selection of one of a plurality of predefined audio profiles.

13. The method of claim 12, wherein the plurality of predefined audio profiles are stored in a local memory of the controller of the household appliance.

14. The method of claim 12, wherein the plurality of predefined audio profiles are stored in a memory of a remote computing device, further comprising downloading the audio profile from the remote computing device to a local memory of the controller of the household appliance.

15. The method of claim 10, wherein the household appliance is a refrigerator appliance, wherein the internal volume is a chilled chamber for receipt of food items and cooling of the food items therein.

16. The method of claim 15, wherein the refrigerator appliance further comprises a dispenser recess, wherein the speaker is positioned adjacent the dispenser recess and oriented into the dispenser recess, wherein operating the speaker to provide the audio output after processing the audio output comprises emitting the audio output into the dispenser recess.

17. The method of claim 10, wherein the audio output comprises voice feedback.

18. The method of claim 10, wherein processing the audio output further comprises equalizing the audio output according to a user-customizable equalizer.
